(19) United States
(12) Patent Application Publication
(10) Pub. No.: US 2012/0234884 A1
(43) Pub. Date: Sep. 20, 2012

(54) BICYCLE HITCH EXTENSION UNIT

(76) Inventor: Larry WITMER, Solon, IA (US)

(21) Appl. No.: 13/414,871

(22) Filed: Mar. 8, 2012

Related U.S. Application Data
(60) Provisional application No. 61/452,171, filed on Mar. 14, 2011.

(51) Int. Cl. B60R 9/10; B60D 1/24

(52) U.S. Cl. 224/520; 224/519; 224/521

(57) ABSTRACT

A bicycle hitch extension unit has a shaft extension portion that removably holds a hitch insert on one end and a receiver hitch on the other end. A bicycle receiver shaft portion is welded to an upper portion of the shaft extension portion and generally centered therein. The bicycle receiver shaft portion removably holds a bicycle rack. The bicycle rack holds bicycles and allows easy access even when a trailer is attached to the receiver hitch. A safety plate is provided as a backup means for securing a safety chain to the end of the extension shaft portion. The shaft extension removably fits with a vehicle hitch.

### CROSS REFERENCE TO RELATED APPLICATIONS

This application claims priority and herein incorporates by reference U.S. provisional patent application 61/452,171, filed Mar. 14, 2011.

### BACKGROUND OF THE INVENTION

Throughout the world, bicycle production and use still outnumbers automobile production and use almost two to one. Bicycles have the advantage of not requiring fuel or at least very little for the powered versions compared to automobiles. Additionally, maintenance is much more accessible and allows even relatively poor users to keep their bicycle operational.

It is often desirable to carry a bicycle using a vehicle so that a user can have use of the bicycle even when not riding it to a particular place. It is known to use bicycle racks that allow a user to secure their bicycle to the rack and carry their bicycle with them. This works well as long as the user only attaches the bicycle rack to the vehicle, but many also attach boats, campers or towed recreational vehicles and this makes it difficult to access the bicycle rack, especially when loading and unloading.

There is a need for a bicycle rack that conveniently allows a user to stow their bikes while still towing a trailer or boat, etc.

### SUMMARY OF THE INVENTION

A bicycle hitch extension unit has a shaft extension portion that removably holds a hitch insert on one end and a receiver hitch on the other end. A bicycle receiver shaft portion is welded to an upper portion of the shaft extension portion and generally centered therein. The bicycle receiver shaft portion removably holds a bicycle rack. The bicycle rack holds bicycles and allows easy access even when a trailer is attached to the receiver hitch. A safety plate is provided as a backup means for securing a safety chain to the end of the extension shaft portion. The shaft extension removably fits with a vehicle hitch.

Other features and advantages of the instant invention will become apparent from the following description of the invention which refers to the accompanying drawings.

### BRIEF DESCRIPTION OF THE DRAWINGS

FIG. 1 is a side view of a bicycle rack extension unit according to the present invention.

FIG. 2 is an end view of the bicycle rack extension unit shown in FIG. 1.

FIG. 3 is a side view of the bicycle rack extension unit shown in FIG. 1 in a typical configuration.

FIG. 4 is a bottom view of the bicycle rack extension unit shown in FIG. 1.

FIG. 5 is a top view of the bicycle rack extension unit shown in FIG. 1.

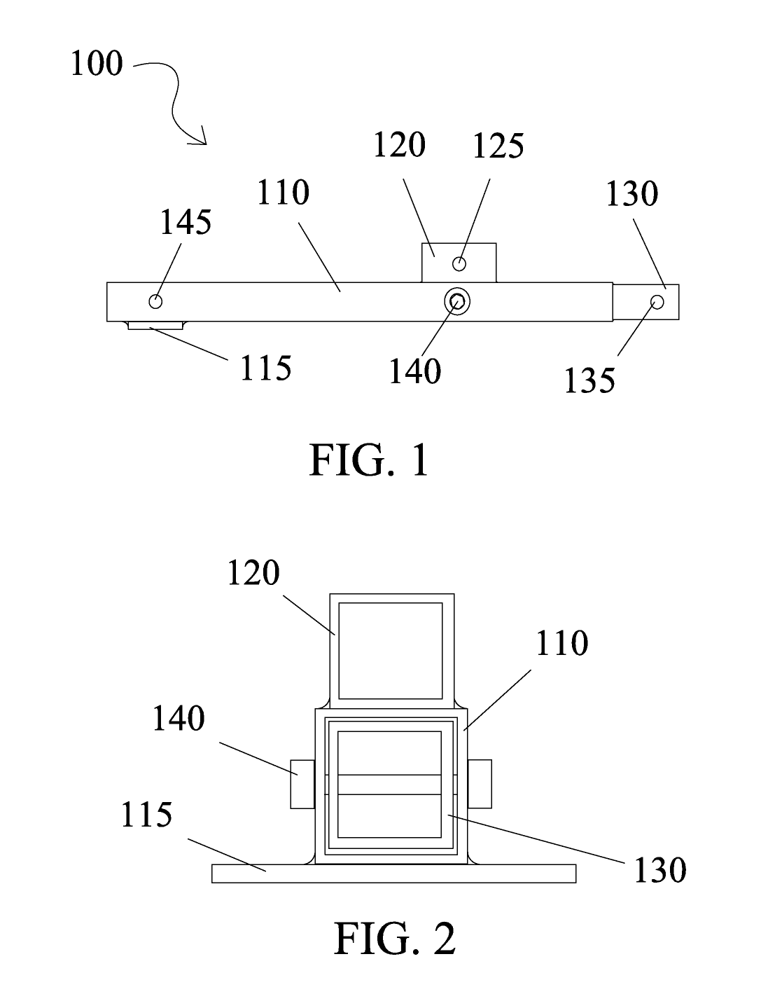

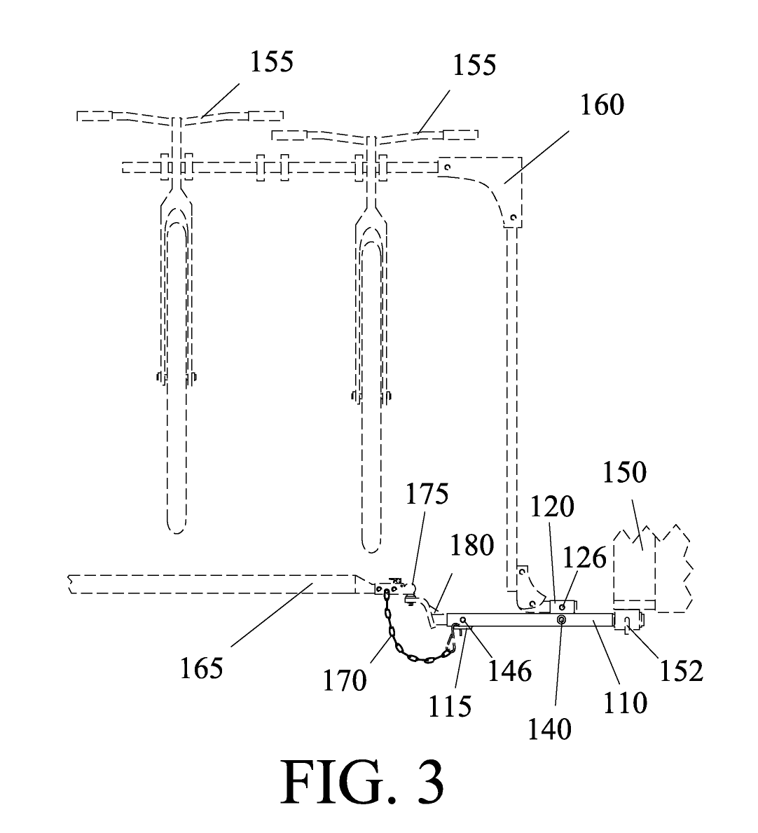

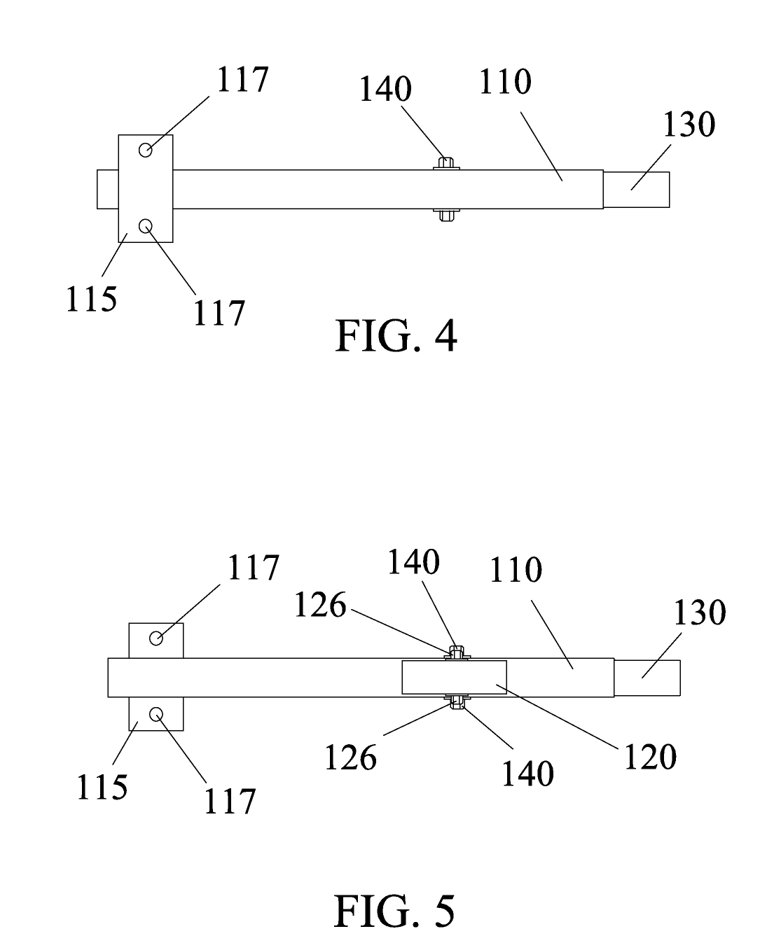

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

Referring to the figures, a bicycle rack extension unit 100 is shown having an extension shaft 110 with a safety plate 115 welded to a lower end portion of extension shaft 110. A hitch insert 130 fits within shaft 110 and is held in place with a shear pin 140. Shear pin 140 may be a welded shear pin or may be removable. Hitch insert 130 has a hitch pin opening 135 therein to allow it to be removably secured to a vehicle hitch receiver 150 with a hitch shear pin 152.

A bicycle receiver shaft 120 is welded to extension shaft 110 and has a bicycle shear pin hole 125 disposed therein allowing a user to removably secure a bicycle rack hitch 160 using shear pin 126. Safety plate 115 is used to secure a chain 170 to a safety chain hole 117 thereby allowing chain 170 to removably connect a trailer tongue 165 as a fail-safe in the case where a coupler 175 fails.

A receiver hitch 180 is removably secured within an end of extension shaft 110 and is secured with a hitch pin 146 that fits in hitch pin opening 145. This allows trailer tongue 165 to connect to the vehicle. Bicycles 155 are secured to bicycle rack as is known in the art. Bicycle rack 160 fits within bicycle receiver shaft 120 rather than fitting directly in vehicle hitch receiver 150.

Extension shaft 110 is long enough to allow the user to conveniently access bicycles 155 while still allowing a trailer, boat, etc. to be towed. Extension shaft 110 is made of steel or other strong material that will not fail under load. Different size shaft 110 may be used to accommodate different size trailer hitches or an adapter may be used.

Although the instant invention has been described in relation to particular embodiments thereof, many other variations and modifications and other uses will become apparent to those skilled in the art.

What is claimed is:

1. A bicycle extension hitch extension unit for use with a vehicle equipped with a towing hitch comprising:
an extension shaft having one end adapted to fit within a vehicle hitch receiver;
said extension shaft having another end adapted to removably hold a receiver hitch; and
a bicycle receiver shaft secured to a top portion of said extension shaft wherein a bicycle rack hitch removably fits within said bicycle receiver shaft.

2. The bicycle extension hitch extension unit for use with a vehicle equipped with a towing hitch according to claim 1 further comprising a safety plate attached to a bottom portion of said extension shaft and generally disposed toward said another end; said safety plate having a chain connecting hole therein wherein a safety chain is connectable therein.

3. The bicycle extension hitch extension unit for use with a vehicle equipped with a towing hitch according to claim 1 wherein said bicycle receiver shaft is welded to said extension shaft.

4. The bicycle extension hitch extension unit for use with a vehicle equipped with a towing hitch according to claim 1 wherein said extension shaft is removably held in place using a shear pin.

5. The bicycle extension hitch extension unit for use with a vehicle equipped with a towing hitch according to claim 1 wherein said bicycle rack hitch is removably held in place using a shear pin.

6. The bicycle extension hitch extension unit for use with a vehicle equipped with a towing hitch according to claim 1 wherein said extension shaft is made of steel square tubing.

7. The bicycle extension hitch extension unit for use with a vehicle equipped with a towing hitch according to claim 1 wherein said receiver hitch is a ball type hitch and said receiver hitch is removably held in place using a shear pin.

8. The bicycle extension hitch extension unit for use with a vehicle equipped with a towing hitch according to claim 1 wherein said bicycle receiver shaft is made of steel square tubing.

9. A bicycle extension hitch extension unit for use with a vehicle equipped with a towing hitch comprising:
a square steel tubing extension shaft;
said square steel tubing having a receiving end and an inserting end;
said inserting end being adapted to fit within a trailer hitch;
said receiving end being adapted to retain a receiving hitch;
a square steel tubing bicycle receiver shaft secured on a top portion of said square steel tubing extension shaft;
a first shear pin opening concentrically disposed on either side of said square steel tubing extension shaft wherein a first shear pin removably secures said extension shaft using matching openings in said trailer hitch to secure said extension shaft to a vehicle;
a second shear pin opening concentrically disposed on either side of said receiving end wherein a second shear pin removably secures a receiver hitch therein; and
a third shear pin opening concentrically disposed on said bicycle receiving shaft wherein a third shear pin removably secures a bicycle rack therein.
